(19) United States
(12) Patent Application Publication
(10) Pub. No.: US 2023/0252284 A1
(43) Pub. Date: Aug. 10, 2023

(54) LEARNING DEVICE, LEARNING METHOD, AND RECORDING MEDIUM

(71) Applicant: NEC Corporation, Minato-ku, Tokyo (JP)

(72) Inventor: Takuma AMADA, Tokyo (JP)

(73) Assignee: NEC Corporation, Minato-ku, Tokyo (JP)

(21) Appl. No.: 18/012,752

(22) PCT Filed: Jun. 30, 2020
(86) PCT No.: PCT/JP2020/025663

§ 371 Date: Dec. 23, 2022

(51) Int. Cl. G06N 3/08; G06N 3/045

(52) U.S. Cl. CPC G06N 3/08; G06N 3/045

(57) ABSTRACT

A learning device includes: an incorrect answer prediction calculation unit which obtains incorrect answer class prediction probability vectors by excluding a correct answer class element from prediction probability vectors of neural network models for supervised learning data; and an updating unit which performs learning of two of the neural network models so as to further reduce a value of an objective function which includes a diversity function, a value of diversity function decreasing as an angle between the incorrect answer class prediction probability vectors of the two neural network models increases.

### TECHNICAL FIELD

The present invention relates to a learning device, a learning method, and a recording medium.

### BACKGROUND ART

As a countermeasure against adversarial examples, in the technique disclosed in Non-Patent Document 1, in order to prevent a plurality of models from being deceived in the same way, learning is performed so that a plurality of models can easily output diverse classification results.

### PRIOR ART DOCUMENTS

### Non-Patent Documents

Non-Patent Document 1: Tianyu Pang and 4 others, “Improving Adversarial Robustness via Promoting Ensemble Diversity”, arXiv:1901.08846, 2019, https://arxiv.org/abs/1901.08846

### SUMMARY OF THE INVENTION

### Problems to be Solved by the Invention

It is desirable that the amount of calculation is small during learning so that a plurality of models can easily output diverse classification results.

For example, in Non-Patent Document 1 mentioned above, the order of the amount of calculation of a function used to obtain diversity in the output of a model (neural network) is O(Lm²+m³). It is desirable to be able to calculate the function used to obtain diversity in the model's output, on an order smaller than this order.

An example object of the present invention is to provide a learning device, a learning method, and a recording medium capable of solving the problems mentioned above.

### Means for Solving the Problem

According to a first example aspect of the present invention, a learning device includes: an incorrect answer prediction calculation unit which obtains incorrect answer class prediction probability vectors by excluding a correct answer class element from prediction probability vectors of neural network models for supervised learning data; and an updating unit which performs learning of two of the neural network models so as to further reduce a value of an objective function which includes a diversity function, a value of diversity function decreasing as an angle between the incorrect answer class prediction probability vectors of the two neural network models increases.

According to a second example aspect of the present invention, a learning method includes: obtaining incorrect answer class prediction probability vectors by excluding a correct answer class element from prediction probability vectors of neural network models for supervised learning data; and performing learning of two of the neural network models so as to further reduce a value of an objective function which includes a diversity function, a value of diversity function decreasing as an angle between the incorrect answer class prediction probability vectors of the two neural network models increases.

According to a third example aspect of the present invention, a recording medium has recorded therein a program for causing a computer to execute: obtaining incorrect answer class prediction probability vectors by excluding a correct answer class element from prediction probability vectors of neural network models for supervised learning data; and performing learning of two of the neural network models so as to further reduce a value of an objective function which includes a diversity function, a value of diversity function decreasing as an angle between the incorrect answer class prediction probability vectors of the two neural network models increases.

### Effects of the Invention

According to the above-described learning device, learning method, and recording medium, a relatively small amount of calculation is required when learning is performed so that a plurality of models can easily output diverse classification results.

### BRIEF DESCRIPTION OF THE DRAWINGS

FIG. 1 is a schematic block diagram showing a configuration example of a learning device according to an example embodiment.

FIG. 2 is a schematic block diagram showing a configuration example of a diversity calculation device according to the example embodiment.

FIG. 3 is a flowchart showing an example of processing performed by the learning device according to the example embodiment.

FIG. 4 is a schematic block diagram showing another configuration example of a learning device according to an example embodiment.

FIG. 5 is a flowchart showing an example of a processing procedure in a learning method according to an example embodiment.

FIG. 6 is a diagram showing a configuration example of an information processing device according to at least one of the example embodiments.

### EXAMPLE EMBODIMENTS

Hereinafter, example embodiments of the present invention are described, however, the present invention within the scope of the claims is not limited by the following example embodiments. Furthermore, all the combinations of features described in the example embodiments may not be essential for the solving means of the invention.

### Description of Configuration in Example Embodiment

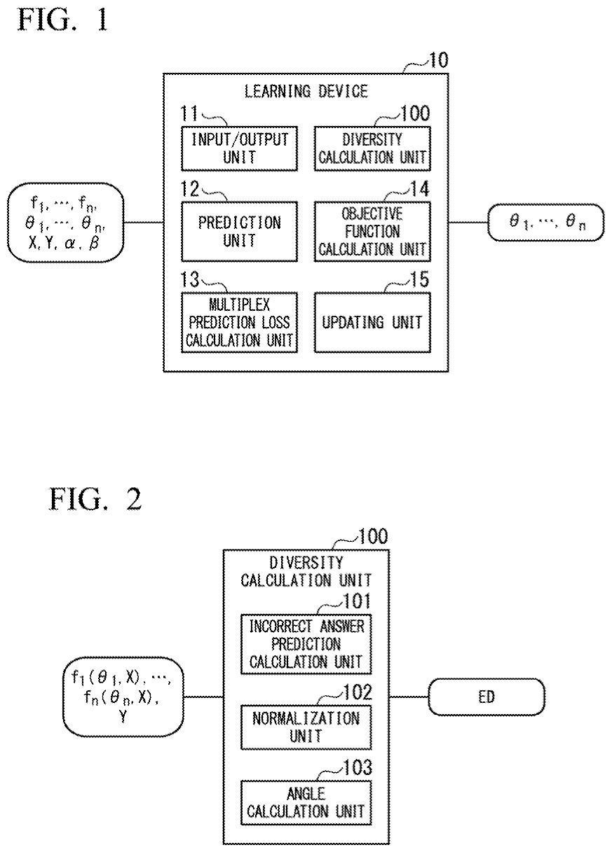

FIG. 1 is a schematic block diagram showing a configuration example of a learning device according to an example embodiment.

In the configuration shown in FIG. 1, a learning device 10 includes an input/output unit 11, a prediction unit 12, a multiplex prediction loss calculation unit 13, a diversity calculation unit 100, an objective function calculation unit 14, and an updating unit 15.

The learning device 10 performs learning of neural network models f₁, . . . , fₙ. Here, n is a positive integer that indicates the number of neural network models to be learned by the learning device 10. A combination of the neural network models f₁, . . . , fₙ is also referred to as a neural network model set.

The learning device 10 performs learning on neural network models so as to provide diversity in output as a neural network model set. As a result, a neural network model set is expected to be developed robustly against adversarial examples.

The adversarial example referred to here is a sample added with minute noise that cannot be recognized by humans (class classification target data). For example, in a case of an adversarial example image, manipulation made thereto is imperceptible or almost imperceptible to the unaided eye.

In addition, the robustness here means that it is unlikely to be mistaken for an adversarial example. That is to say, a normal sample, which is an original sample of the adversarial example, is unlikely to be classified into classes other than the correct answer class.

For example, in the case where a neural network model set learned by the learning device 10 outputs a plurality of classes of classification results, and among the plurality of classes, the number of the neural network models that output the correct answer class is the largest, a correct answer can be obtained by taking the majority vote of the output of the neural network model. At this time, by diversifying outputs of the collected neural network models, it is possible to reduce the possibility of the neural network models f₁, . . . , fₙ from being deceived.

Moreover, as a result of the neural network model set learned by the learning device 10 making multiple outputs of classification result classes, then even in a case where the correct answer class cannot be identified, it is possible to indicate the possibility of input data being an adversarial example.

The input/output unit 11 inputs and outputs data to and from the outside of the learning device 10.

For example, the input/output unit 11 accepts inputs of the neural network models f₁, . . . , fₙ and an input of the initial values of parameters θ₁, . . . , θₙ of each neural network model, an input of training data X, an input of a correct answer label and inputs of values of hyper parameters α and β.

The neural network model fᵢ (i is an integer where 1≤i≤n) may include multiple parameters, and the parameter θᵢ may be configured as a vector with multiple parameters. Also, the neural network models f₁, . . . , fₙ may each have a different configuration and a different number of parameters, and the parameters θ₁, . . . , θₙ may each have a different number of elements.

Also, the input/output unit 11 outputs the values of the parameters θ₁, . . . , θₙ that have been updated by means of learning. The values of the parameters θ₁, . . . , θₙ that have been updated by means of learning are also expressed as parameter values θ′₁, . . . , θ′ₙ.

Alternatively, in addition to or in place of output of the parameter values θ′₁, . . . , θ′ₙ, the learning device 10 may use the neural network models f₁, . . . , fₙ and the parameter values θ′₁, . . . , θ′ₙ to function as a classifier, and may output class classification results upon receiving data input.

The method in which the input/output unit 11 inputs and outputs data is not limited to a particular method. For example, the input/output unit 11 may have a communication function such as including a communication device to transmit or receive data to or from another device. Alternatively, the input/output unit 11 may include an input device such as a keyboard and a mouse, and may accept input of data by a user operation in addition to or instead of data reception. Also, the input/output unit 11 may include a display screen such as a liquid crystal panel or an LED (Light Emitting Diode) panel to display data in addition to or instead of data transmission.

On the basis of the neural network models f₁, . . . , fₙ and the training data X, the prediction unit 12 calculates and outputs prediction probability vectors f₁(X, θ₁), . . . fₙ(X, θₙ) of the neural network models.

The prediction probability vector referred to here is an output of a neural network model and indicates a prediction probability of each class. That is to say, in response to an input of data, for each class, the neural network model fᵢ (i is an integer where 1≤i≤n) outputs a probability of a classification target associated with the data belonging to the class. The prediction unit 12 calculates the output of the neural network model fᵢ with respect to the input of the training data X on the basis of the parameter θᵢ and outputs it as a prediction probability vector fᵢ(X, θᵢ).

On the basis of the prediction probability vectors f₁(X, θ₁), . . . , fₙ(X, θₙ) and a correct answer label Y, the multiplex prediction loss calculation unit 13 calculates and outputs an index value indicating the magnitude of error between prediction results of the neural network models f₁, . . . , fₙ and the correct answer label. A function for calculating the index value indicating the magnitude of error between the prediction results of the neural network models f₁, . . . , fₙ and the correct answer label is referred to as a multiplex prediction loss function ECE. The value of the multiplex prediction loss function ECE is referred to as multiplex prediction loss.

For example, the prediction loss of fᵢ may be lᵢ, and the multiplex prediction loss function ECE may be the average value of lᵢ. Cross entropy may be used for In such a case, the multiplex prediction loss calculation unit 13 calculates the multiplex prediction loss, using the multiplex prediction loss function ECE expressed as Equation (1).

$$[ Equation 1 ]$$

$$ECE = \frac{1}{n} \sum - log ( {1}_{Y} {f}_{i} ( X , {θ}_{i} ) ) \qquad ( 1 )$$

“l_{Y}” indicates a one-hot vector in which the Y-th element is 1 and the other elements are 0. “−log(l_{Y}fᵢ(X, θᵢ))” indicates the prediction loss due to cross-entropy in the neural network model fᵢ and is expressed as −log(pᵢ(Y)). Here, pᵢ(Y) is a prediction probability that the neural network model fᵢ outputs for the correct answer label Y (correct answer class).

However, the multiplex prediction loss function ECE is not limited to that expressed as Equation (1). Various functions, in which error becomes smaller as the output of the neural network model is closer to the correct answer, can be used as the multiplex prediction loss function ECE.

The learning device 10 performs learning on the neural network models f₁, . . . , fₙ so as to reduce the value of the multiplex prediction loss function ECE, thereby increasing the accuracy of class classification by means of the neural network models f₁, . . . , fₙ.

On the basis of the prediction probability vectors f₁(X, θ₁), . . . fₙ(X, θₙ) and the correct answer label Y, the diversity calculation unit 100 calculates an index value indicating the diversity in the outputs of the neural network models f₁, . . . , fₙ. A function for calculating the index value indicating the diversity in the outputs of the neural network models f₁, . . . , fₙ is referred to as a diversity function ED. As the diversity function ED, a function, the value of which decreases as the diversity in the outputs of the neural network models f₁, . . . , fₙ increases, is used. That is to say, for the same training data X, the greater the variation in the prediction probability vectors f₁(X, θ₁), . . . , fₙ(X, θₙ), the smaller the value of the diversity function ED becomes.

By reducing the value of the diversity function ED through learning, the prediction probability vectors f₁(X, θ₁), . . . , fₙ(X, θₙ) are diversified, which has an effect of making the neural network models f₁, . . . , fₙ robust against the input of adversarial examples.

As shown in the example of FIG. 1, the diversity calculation unit 100 may be configured as a part of the learning device 10. Alternatively, the diversity calculation unit 100 may be configured as a separate device from the learning device 10.

The objective function calculation unit 14 calculates the value of an objective function, on the basis of the value of the multiplex prediction loss function ECE calculated by the multiplex prediction loss calculation unit 13, the ED output from the diversity calculation unit 100, and the values of the hyper parameters α and β. The objective function can be, for example, loss=αECE−βED.

The updating unit 15 performs learning of the neural network models f₁, . . . , fₙ. Specifically, on the basis of the value of the objective function calculated by the objective function calculation unit 14, the updating unit 15 updates the values of the parameters θ₁, . . . , θₙ of the neural network models, so that the difference between the output of the neural network and the correct answer label becomes smaller and the similarity between neural network models becomes lower.

For example, the updating unit 15 may calculate the values of the parameters θ₁, . . . , θₙ that reduce the value of the objective function on the basis of a gradient method, using a differential coefficient of the objective function with respect to each parameter of the neural network. However, the learning method used by the updating unit 15 is not limited to a particular method. As a method for the updating unit 15 to learn the neural network models f₁, . . . , fₙ, various methods can be used to reduce the value of the objective function.

FIG. 2 is a schematic block diagram showing a configuration example of the diversity calculation unit 100. In the configuration shown in FIG. 2, the diversity calculation unit 100 includes an incorrect answer prediction calculation unit 101, a normalization unit 102, and an angle calculation unit 103.

The diversity calculation unit 100 accepts prediction probability vectors f₁(X, θ₁), . . . , fₙ(Xₙ, θₙ) and the correct answer label from the prediction unit 12 as inputs.

Here, the classes are associated with numbers from 1 to n, and these numbers are used to refer to class 1, . . . , class n. Also, in each of the prediction probability vectors f₁ (X, θ₁), . . . , (Xₙ, θₙ) as elements of the vectors, the prediction probability of the class 1 to the prediction probability of the class n are arranged sequentially. Y indicates the number of the correct answer class.

However, the method of identifying a class, the method of presenting a correct answer class, and the configuration of a prediction probability vector are not limited to particular ones.

The incorrect answer prediction calculation unit 101 calculates and outputs incorrect answer class prediction probability vectors f₁^{Y}(X, θ₁), . . . fₙ^{Y}(X, θₙ) excluding the element corresponding to the correct answer label of each f₁(X, θ₁), that is, the Y-th element.

The normalization unit 102 normalizes and outputs the incorrect answer class prediction probability vectors f₁^{Y}(X, θ₁), . . . , fₙ^{Y}(X, θₙ). This is to eliminate the influence of the magnitude of the vectors when the diversity calculation unit 100 calculates the value of the diversity function ED (diversity index value) on the basis of the incorrect answer class prediction probability vectors f₁^{Y}(X, θ₁), . . . fₙ^{Y}(X, θₙ).

As the normalization performed by the normalization unit 102, various normalizations for vectors can be used. For example, the normalization unit 102 may perform L2 normalization, however, it is not limited to this example. Alternatively, the diversity calculation unit 100 may not include the normalization unit 102. That is to say, normalization of the incorrect answer class prediction probability vectors f₁^{Y}(X, θ₁), . . . fₙ^{Y}(X, θₙ) performed by the normalization unit 102 is not essential.

In the case where the normalization unit 102 performs L2 normalization on the incorrect answer class prediction probability vectors f₁^{Y}(X, θ₁), . . . , fₙ^{Y}(X, θₙ), calculation is performed as in Equation (2).

$$[ Equation 2 ]$$

$${f}_{i} NORM = \frac{{f}_{i}^{Y} ( X , {θ}_{i} )}{{\vert {f}_{i}^{Y} ( X , {θ}_{i} ) \vert}_{2}} \qquad ( 2 )$$

The angle calculation unit 103 calculates and outputs the value of the diversity function ED. For example, in the case where the normalization unit 102 performs L2 normalization, the function expressed as Equation (3) can be used as the diversity function ED.

$$[ Equation 3 ]$$

$$ED = {\sum }_{1 \leq i \leq j \leq n} ( {f}_{i} NORM \cdot {f}_{j} NORM ) \qquad ( 3 )$$

“·” in Equation (3) indicates the inner product of vectors.

The angle calculation unit 103 calculates, as a diversity index value, the sum of the cosine similarities of the incorrect answer class prediction probability vectors for all combinations of two incorrect answer class prediction probability vectors in the neural network models f₁, . . . , fₙ, on the basis of Equation (3). The larger the variation in the incorrect answer class prediction probability vectors, the smaller the cosine similarities and the smaller the diversity index value (the value of the diversity function ED).

Alternatively, the angle calculation unit 103 may calculate the average of the inner products as in Equation (4), instead of the sum of the inner products of the normalized incorrect answer class prediction probability vectors.

$$[ Equation 4 ]$$

$$ED = \frac{1}{n} {\sum }_{1 \leq i \leq j \leq n} ( {f}_{i} NORM \cdot {f}_{j} NORM ) \qquad ( 4 )$$

As in the example of Equation (3) or Equation (4), as the diversity function ED, there may be used a function the value of which becomes smaller as the angle between the incorrect answer class prediction probability vectors i_{f}(X, θᵢ) and fⱼ^{Y}(X, θⱼ) of the two neural network models fᵢ and fⱼ (i, j are positive integers where 1≤i≤j≤n) becomes greater.

Moreover, Equation (3) and Equation (4) both correspond to an example of the diversity function ED that includes computation of the evaluation value of the magnitude of the angle between the incorrect answer class prediction probability vectors fᵢ^{Y}(X, θᵢ) and fⱼ^{Y}(X, θⱼ), for all combinations of the two neural network models fᵢ and fⱼ among all of the learning target neural network models f₁, . . . , fₙ.

However, as the diversity function ED, there may be used a function that includes computation of an evaluation value of the magnitude of the angle between the incorrect answer class prediction probability vectors, only for some combinations of two of the neural network models among all of the learning target neural network models.

For example, as in the example of Equation (5), the angle calculation unit 103 may calculate the value of the diversity function ED that includes computation of an evaluation value of the magnitude of the angle between the incorrect answer class prediction probability vectors that are adjacent to each other in terms of their identification numbers.

$$[ Equation 5 ]$$

$$ED = ( {\sum }_{1 \leq i \leq n - 1} ( {f}_{i} NORM \cdot {f}_{i + 1} NORM ) ) + {f}_{n} NORM \cdot {f}_{1} NORM \qquad ( 5 )$$

Computation of an evaluation value of the magnitude of the angle used for the diversity function ED is not limited to cosine similarity, and various functions can be used in which the larger the angle, the smaller the value.

### [Description of Operation of Learning Device]

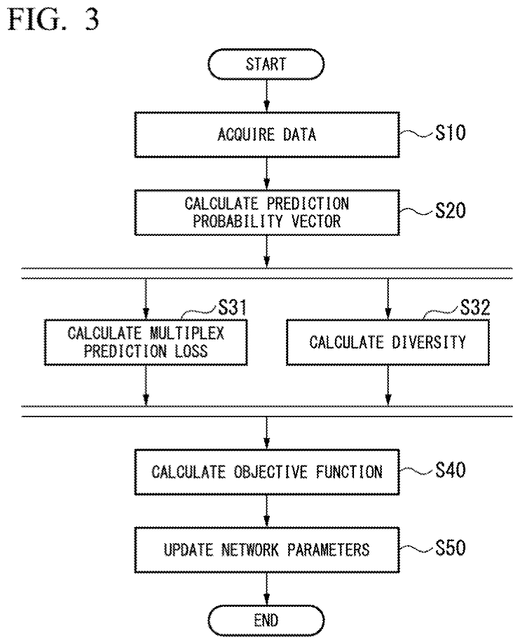

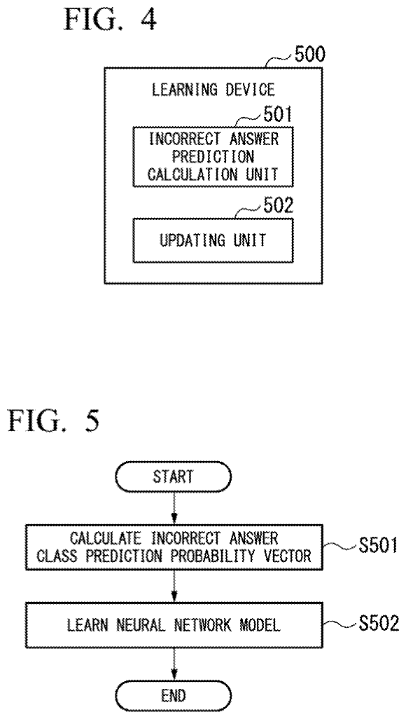

FIG. 3 is a flowchart showing an example of processing performed by the learning device 10.

First, the input/output unit 11 acquires n neural network models f₁, . . . , fₙ, values of parameters θ₁, . . . , θₙ, training data X, correct answer label Y, and values of hyper parameters α and β (Step S10).

Next, the prediction unit 12 calculates the prediction probability vectors f₁(X, θ₁), . . . , fₙ(X, θₙ) of each neural network model (Step S20).

Next, the multiplex prediction loss calculation unit 13 calculates errors between the prediction probability vectors f₁(X, θ₁), . . . , fₙ(X, θₙ) and the correct answer, and calculates the average value between the models, to thereby calculate the value of the multiplex prediction loss function ECE (Step S31).

Next, on the basis of the prediction probability vectors f₁(X, θ₁), . . . , fₙ(X, θₙ) and the correct answer label Y, the diversity calculation unit 100 calculates incorrect answer class prediction probability vectors f₁^{Y}(X, θ₁), . . . , fₙ^{Y}(X, θₙ), and calculates, as a diversity numerical value (diversity function ED), a score based on the angle between these vectors (Step S32).

Next, the objective function calculation unit 14 calculates an objective function loss, on the basis of the multiplex prediction loss function ECE, the diversity function ED, and the values of hyper parameters α and β (Step S4).

Lastly, the updating unit 15 updates the network parameters θ₁, . . . , θₙ according to the value of the differential coefficient obtained when the objective function loss is differentiated with the network parameters θ₁, . . . , θₙ (Step S5). That is to say, the updating unit 15 calculates updated network parameters θ′₁, . . . , θ′ₙ.

After Step S4, the learning device 10 ends the process of FIG. 3.

The learning device 10 repeatedly performs the process of FIG. 3. For example, the learning device 10 may repeat the process of FIG. 3 a predetermined number of times. Alternatively, the learning device 10 may repeat the process until the magnitude of the decrease rate of the objective function converges to or below a predetermined magnitude.

As described above, the incorrect answer prediction calculation unit 101 calculates incorrect answer class prediction probability vectors f₁^{Y}(X, θ₁), . . . , fₙ^{Y}(X, θₙ), excluding correct answer class elements from the prediction probability vectors of the neural network models f₁, . . . , fₙ for the training data X. The updating unit 15 performs learning of the neural network models f₁, . . . , fₙ so as to further reduce the value of the objective function loss, which includes the diversity function ED, the value of which decreases with an increasing angle between the incorrect answer class prediction probability vectors of the two neural network models.

As a result of the updating unit 15 performing learning of the neural network models f₁, . . . , fₙ so as to reduce the value of the objective function loss, the value of the loss function included in the objective function loss becomes smaller, and the classification accuracy by means of the neural network models f₁, . . . , fₙ is expected to increase.

Also, as a result of the updating unit 15 performing learning of the neural network models f₁, . . . , fₙ so as to reduce the value of the objective function loss, the value of the diversity function included in the objective function loss becomes smaller, and diversity is expected to be obtained in the output of the neural network models f₁, . . . , fₙ (output of neural network set). As a result of the outputs of the neural network models f₁, . . . , fₙ becoming diversified, robustness is expected to be obtained against adversarial examples.

In addition, the amount of calculation in learning is expected to become comparatively smaller in terms of the updating unit 15 using, as the diversity function, a function based on the evaluation value of the angle between incorrect answer class prediction probability vectors among the two neural network models.

For example, where the number of neural network models is m and the number of output vector classes (number of classes) is L, the amount of calculation in the function used for obtaining diversity in the output of the neural network models is the order of O (Lm²+m³) in Non-Patent Document 1 mentioned above, whereas it is merely O (Lm²) according to the learning device 10.

Moreover, the diversity function includes computation of the evaluation value of the magnitude of the angle between the class prediction probability vectors, for all combinations of two of the neural network models among all of the learning target neural network models f₁, . . . , fₙ.

As a result, the learning device 10 is expected to be able to highly accurately evaluate the output diversity of the neural network models, and is thus expected to easily obtain diversity in the output of the neural network models.

Moreover, the diversity function includes, as computation of the magnitude of the angle between two of the incorrect answer class prediction probability vectors, calculation of cosine similarity of the two incorrect answer class prediction probability vectors.

As a result, the learning device 10 can eliminate the influence of the magnitude of each of the two incorrect answer class prediction probability vectors when evaluating the magnitude of the angle between the two incorrect answer class prediction probability vectors. In this regard, the learning device 10 is expected to be able to highly accurately evaluate the output diversity of the neural network models, and is thus expected to easily obtain diversity in the output of the neural network models.

Moreover, the diversity function includes computation to calculate the average of cosine similarities of the incorrect answer class prediction probability vectors of two of the neural network models, for all combinations of two of the neural network models among all of the neural network models that are the learning target.

Accordingly, by calculating the average of cosine similarities through calculation of the diversity function, the learning device 10 can avoid increase or decrease in the value of the diversity function, depending on the number of neural network models, and avoid variation in the degree of influence of the diversity function on the objective function.

FIG. 5 is a schematic block diagram showing another configuration example of a learning device according to an example embodiment.

In the configuration shown in FIG. 5, the learning device 500 includes an incorrect answer prediction calculation unit 501 and an updating unit 502.

In this configuration, the incorrect answer prediction calculation unit 501 obtains an incorrect answer class prediction probability vector by excluding correct answer class elements from the prediction probability vector of a neural network model for supervised learning data. The updating unit 502 performs learning of neural network models so as to further reduce the value of the objective function, which includes the diversity function, the value of which decreases with an increasing angle between the incorrect answer class prediction probability vectors of two of the neural network models.

As a result of the updating unit 502 performing learning of the neural network models so as to reduce the value of the objective function, the value of the diversity function included in the objective function becomes smaller, and diversity is expected to be obtained in the output of the neural network models. As a result of the outputs of the neural network models becoming diversified, robustness is expected against adversarial examples.

In addition, the amount of calculation in learning is expected to become comparatively smaller in terms of the updating unit 502 using, as the diversity function, a function based on the evaluation value of the angle between incorrect answer class prediction probability vectors among the two neural network models.

For example, where the number of neural network models is m and the number of output vector classes (number of classes) is L, the amount of calculation in the function used for obtaining diversity in the output of the neural network models is the order of O (Lm²+m³) according to Non-Patent Document 1 mentioned above, whereas it is merely O (Lm²) according to the learning device 500.

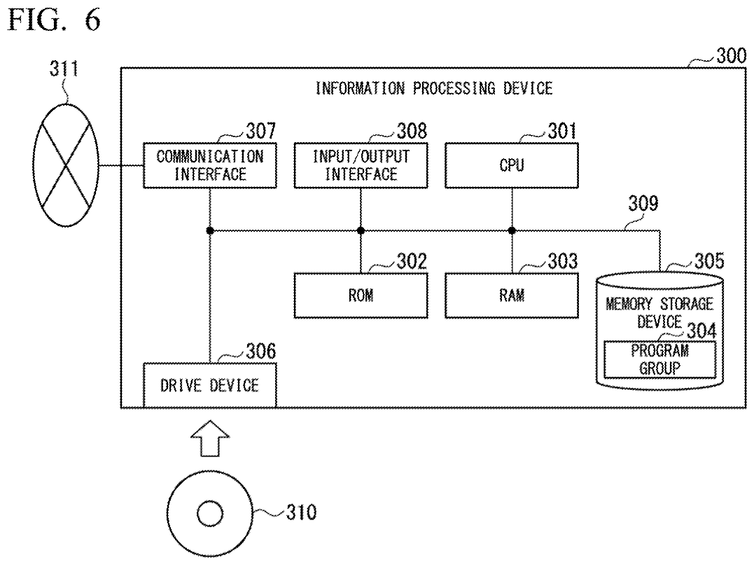

FIG. 6 is a flowchart showing an example of a processing procedure in a learning method according to an example embodiment. The processing shown in FIG. 6 obtains an incorrect answer class prediction probability vector by excluding correct answer class elements from a prediction probability vector of a neural network model for supervised learning data (Step S501). Then, the processing performs learning of the neural network models so as to further reduce the value of the objective function, which includes the diversity function, the value of which decreases with an increasing angle between the incorrect answer class prediction probability vectors of two of the neural network models (Step S502).

As a result of performing learning of the neural network models so as to reduce the value of the objective function, the value of the diversity function included in the objective function becomes smaller, and diversity is expected to be obtained in the output of the neural network models. As a result of the outputs of the neural network models becoming diversified, robustness is expected against adversarial examples.

In addition, the amount of calculation in learning is expected to become comparatively smaller in terms of using, as the diversity function, a function based on the evaluation value of the angle between incorrect answer class prediction probability vectors among the two neural network models.

For example, where the number of neural network models is m and the number of output vector classes (number of classes) is L, the amount of calculation in the function used for obtaining diversity in the output of the neural network models is the order of O (Lm²+m³) according to Non-Patent Document 1 mentioned above, whereas it is merely O (Lm²) according to the processing shown in FIG. 6.

### Hardware Configuration

FIG. 7 is a diagram showing a configuration example of an information processing device 300 according to at least one of the example embodiments. In the configuration shown in FIG. 7, the information processing device 300 includes a CPU (Central Processing Unit) 301, a ROM (Read Only Memory) 302, a RAM (Random Access Memory) 303, a program group 304 to be loaded into the RAM 303, a storage device 305 that stores the program group 304, a drive device 306 that reads and writes a recording medium 310 outside the information processing device 300, a communication interface 307 that connects to a communication network 311 outside the information processing device 300, an input/output interface 308 that performs data input and output, and a path 309 that connects each component.

Part or all of the learning device 10 described above or part or all of the learning device 500 may be realized by the information processing device 300 shown in FIG. 7 executing a program, for example. In such a case, this can be realized by the CPU 301 acquiring and executing the program group 304 that realizes the functions of the respective processing units described above. The program group 304 that realizes the function of each unit of the learning device 10 or the learning device 500 is stored preliminarily in the storage device 305 or the ROM 302, for example, and is loaded into the RAM 303 and executed by the CPU 301 as necessary. It should be noted that the program group 304 may be supplied to the CPU 301 via the communication network 311 or be preliminarily stored in the recording medium 310, and the drive device 306 may read the program and supply it to the CPU 301.

It should be noted that FIG. 7 only shows an example of the configuration of the information processing device 300, and the configuration of the information processing device 300 is not meant to be illustrated in the case described above. For example, the information processing device 300 may be configured with part of the configuration described above, and the configuration thereof may not have the drive device 306.

In the case where the learning device 10 is implemented in the information processing device 300, operations of the prediction unit 12, the multiplex prediction loss calculation unit 13, the objective function calculation unit 14, the updating unit 15, the incorrect answer prediction calculation unit 101, the normalization unit 102, and the angle calculation unit 103 are stored, for example, in the form of a program in the storage device 305 or in the ROM 302. The CPU 301 reads out the program from the storage device 305 or from the ROM 302, loads it on the RAM 303, and executes the processing described above in accordance with the program.

Moreover, the CPU 301 secures a storage region in the RAM 303 in accordance with the program. In the case where the input/output unit 11 performs communication with another device, the communication interface 307 executes communication under the control of the CPU 301. In the case where the input/output unit 11 accepts data input such as data input performed through user operations, the input/output interface 308 accepts data input. For example, the input/output interface 308 may include an input device such as a keyboard and a mouse, and accept user operations. In the case where the input/output unit 11 outputs data such as by displaying the data, the input/output interface 308 executes data output. For example, the input/output interface 308 may include a display screen such as a liquid crystal panel or an LED panel to display data.

In the case where the learning device 500 is implemented in the information processing device 300, operations of the incorrect answer prediction calculation unit 501 and the updating unit 502 are stored, for example, in the form of a program in the storage device 305 or in the ROM 302. The CPU 301 reads out the program from the storage device 305 or from the ROM 302, loads it on the RAM 303, and executes the processing described above in accordance with the program.

Moreover, the CPU 301 secures a storage region in the RAM 303 in accordance with the program. In the case where the learning device 500 performs communication with another device, the communication interface 307 executes communication under the control of the CPU 301. In the case where the learning device 500 accepts data input such as data input performed through user operations, the input/output interface 308 accepts data input. For example, the input/output interface 308 may include an input device such as a keyboard and a mouse, and accept user operations. In the case where the learning device 500 outputs data such as by displaying the data, the input/output interface 308 executes data output. For example, the input/output interface 308 may include a display screen such as a liquid crystal panel or an LED panel to display data.

As described above, a program for executing all or part of the processes performed by the learning device 10 and the learning device 500 may be recorded on a computer-readable recording medium, and the program recorded on the recording medium may be read into and executed on a computer system, to thereby perform the processing of each unit. The “computer system” here includes an OS and hardware such as peripheral devices.

Moreover, the “computer-readable recording medium” referred to here refers to a portable medium such as a flexible disk, a magnetic optical disk, a ROM (Read Only Memory), and a CD-ROM (Compact Disc Read Only Memory), or a memory storage device such as a hard disk built in a computer system. The above program may be a program for realizing a part of the functions described above, and may be a program capable of realizing the functions described above in combination with a program already recorded in a computer system.

The example embodiments of the present invention have been described in detail with reference to the drawings. However, the specific configuration of the invention is not limited to the example embodiments, and may include designs and so forth that do not depart from the scope of the present invention.

### INDUSTRIAL APPLICABILITY

The example embodiments of the present invention may be applied to a learning device, a learning method, and a recording medium.

### DESCRIPTION OF REFERENCE SIGNS

10 Learning device
11 Input/output unit
12 Prediction unit
13 Multiplex prediction loss calculation unit
14 Objective function calculation unit
15 Updating unit
100 Diversity calculation unit
101 Incorrect answer prediction calculation unit
102 Normalization unit
103 Angle calculation unit
201 Inner product sum calculation unit

What is claimed is:

1. A learning device comprising:
a memory configured to store instructions; and
a processor configured to execute the instructions to:
obtain incorrect answer class prediction probability vectors by excluding a correct answer class element from prediction probability vectors of neural network models for supervised learning data; and
perform learning of two of the neural network models so as to further reduce a value of an objective function which includes a diversity function, a value of diversity function decreasing as an angle between the incorrect answer class prediction probability vectors of the two neural network models increases.

2. The learning device according to claim 1, wherein the diversity function includes computation of an evaluation value of a magnitude of an angle between the incorrect answer class prediction probability vectors, for all combinations of two of the neural network models among all of the neural network models that are a learning target.

3. The learning device according to claim 1, wherein the diversity function includes, as computation of an evaluation value of a magnitude of an angle between two of the incorrect answer class prediction probability vectors, calculation of cosine similarity of the two incorrect answer class prediction probability vectors.

4. The learning device according to claim 1, wherein the diversity function includes computation to calculate an average of cosine similarities of the incorrect answer class prediction probability vectors of two of the neural network models, for all combinations of two of the neural network models among all of the neural network models that are a learning target.

5. A learning method comprising:
obtaining incorrect answer class prediction probability vectors by excluding a correct answer class element from prediction probability vectors of neural network models for supervised learning data; and
performing learning of two of the neural network models so as to further reduce a value of an objective function which includes a diversity function, a value of diversity function decreasing as an angle between the incorrect answer class prediction probability vectors of the two neural network models increases.

6. A non-transitory recording medium having recorded therein a program for causing a computer to execute:
obtaining incorrect answer class prediction probability vectors by excluding a correct answer class element from prediction probability vectors of neural network models for supervised learning data; and
performing learning of two of the neural network models so as to further reduce a value of an objective function which includes a diversity function, a value of diversity function decreasing as an angle between the incorrect answer class prediction probability vectors of the two neural network models increases.
